(19) United States
(12) Patent Application Publication
(10) Pub. No.: US 2006/0269720 A1
(43) Pub. Date: Nov. 30, 2006

(54) Hollow core board

(76) Inventor: Gerald Guanci, Chicago, IL (US)

Correspondence Address: BEEM PATENT LAW FIRM, 53 W. JACKSON BLVD., SUITE 1352, CHICAGO, IL, 60604-3787, US

(21) Appl. No.: 11/140,093

(22) Filed: May 27, 2005

(51) Int. Cl. B32B 3/00

(52) U.S. Cl. 428/72; 428/68; 428/71

(57) ABSTRACT

A hollow core board product has a core and a relatively thin skin is attached to either side of the core, the skin having a peripheral shape conforming to the desired shape of the product. In one embodiment, the core is a grid having a preselected number of elongated linear grid members, the members being selected and configured to have a relatively high compression resistance, and being interlocked in a crossing pattern to form the grid, such that the number of grid members utilized and their spacing will determine a load bearing capacity of the hollow core board product. In another embodiment, at least one solid block member is inserted at a desired location in the core and positioned so as to closely abut at least one of the skins. A frame may also be provided if desired.

### BACKGROUND OF THE INVENTION

1. Field of the Invention

The present invention is directed to a novel and improved hollow core board product.

2. Description of the Related Art

Laminated composite construction products are currently available from a number of suppliers. Perhaps the best-known of such products is the hollow core door, commonly used in commercial and residential construction. Typically, such products are not intended to be used in load-bearing applications. Accordingly, the internal components of such structure are normally not load-bearing, such as foam or other formable products, or corrugated paper product “honeycomb” fillers, or the like. Some such products are made for only temporary use and are essentially disposable as in disposable packaging or the like. Other products, such as doors and the like are not meant to be load-bearing. In addition to the non-load-bearing character of such products, the nature of the usual interior filling is such that deformation or warpage is possible or even likely, even in the absence of significant loads. Many foam-filled hollow core doors naturally warp over a period of time, due to the lack of structural strength and integrity of the product. Typically, such a product has relatively thin outer skins laminated or otherwise attached over a frame, with the space between the skins filled with a foam or other formable products, corrugated paper or cardboard type products or the like.

Generally speaking, all of the products used for the interiors of hollow core products today lack structural integrity and load-bearing capacity. Accordingly, such products are generally not readily usable for high load-bearing capacity applications such as shelving, or as structural members, for example, in prefabricated panels for use in flooring, platforms, truck trailer or mobile home/travel trailer walls or partitions, office partitions or cubicle walls, portable dance floors, countertops exhibits, or the like, or for use as components of furniture products, such as modular furniture products which are preassembled or assembled by the consumer.

Moreover, the interior fillers of standard hollow core products as described above generally did not provide a secure mounting for fasteners or the like, so as to be usable for mounting other objects, such as hooks, hardware, etc. or for use in multiple piece constructions requiring attachment to other members in.

### BRIEF SUMMARY OF THE INVENTION

A novel hollow core board product is provided for use in applications which would otherwise employ conventional solid or hollow core board products. One such hollow core board product comprises a frame having a desired shape, and having one or more peripheral frame members, forming an open space inside of the peripheral members. A core is shaped to fit in the open space on the inside of the peripheral members, and a relatively thin skin is attached to either side of the frame so as to enclose the core therein, with the skin having a peripheral shape conforming to the desired shape of the frame.

In one embodiment, a core is provided in the form of a grid having a preselected number of elongated linear grid members, the members being selected and configured to have a relatively high compression resistance, and being interlocked in a crossing pattern to form the grid, such that the number of grid members utilized and their spacing will determine a load bearing capacity of the hollow core board product. A relatively thin skin may be attached to either side of the core.

In another embodiment, at least one solid block member is inserted at a desired location in the core and positioned so as to closely abut at least one of the skins.

These and other features and advantages are evident from the following description of the present invention, with reference to the accompanying drawings.

### BRIEF DESCRIPTION OF THE SEVERAL VIEWS OF THE DRAWINGS

FIG. 1 is an exploded perspective view illustrating components of a hollow core board product in accordance with one embodiment of the invention;

FIG. 2 is a top plan view of the hollow core board product of claim 1;

FIG. 3 is an exploded perspective view illustrating a lattice like support portion of the hollow core board product of FIGS. 1 and 2;

FIG. 4 is a simplified top plan view, illustrating an alternative form of support lattice;

FIG. 5 is a simplified top plan view illustrating another form of support lattice structure;

FIG. 6 is a simplified top plan view, illustrating yet another form of support lattice structure;

FIG. 7 is a simplified top plan view, illustrating yet another form of support lattice structure;

FIG. 8 is a simplified top plan view, illustrating yet another form of support lattice structure;

FIG. 9 is a perspective view illustrating an assembled lattice structure having a foam or other formable material filling in the spaces in the grid;

FIG. 10 is an exploded perspective view illustrating placement of several solid fastener-receiving blocks in the lattice support structure;

FIG. 11 is an enlarged perspective view of one form of a solid fastener-receiving block; and

FIG. 12 is an exploded perspective view of another form of solid fastener-receiving block.

### DETAILED DESCRIPTION OF THE INVENTION

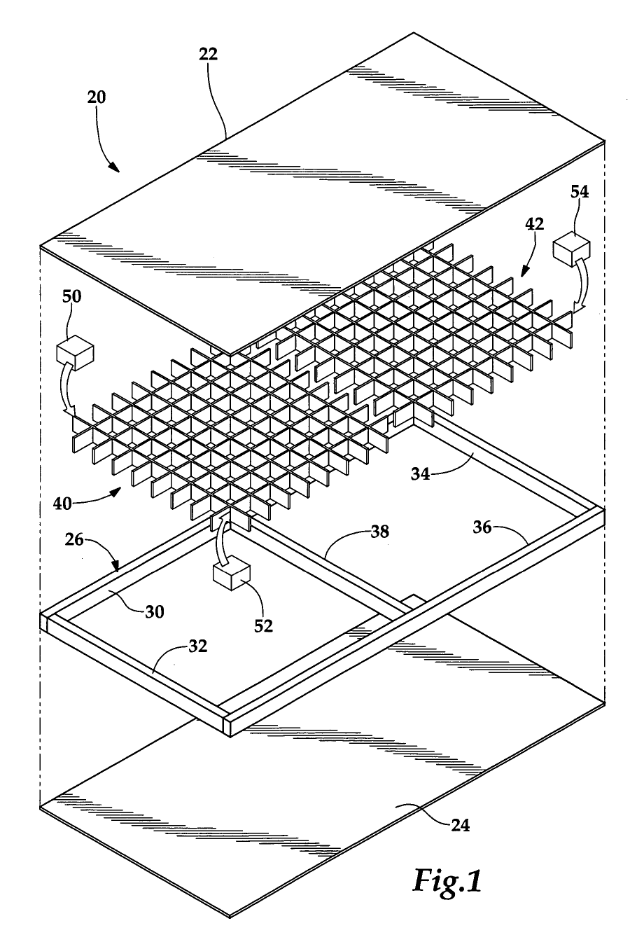

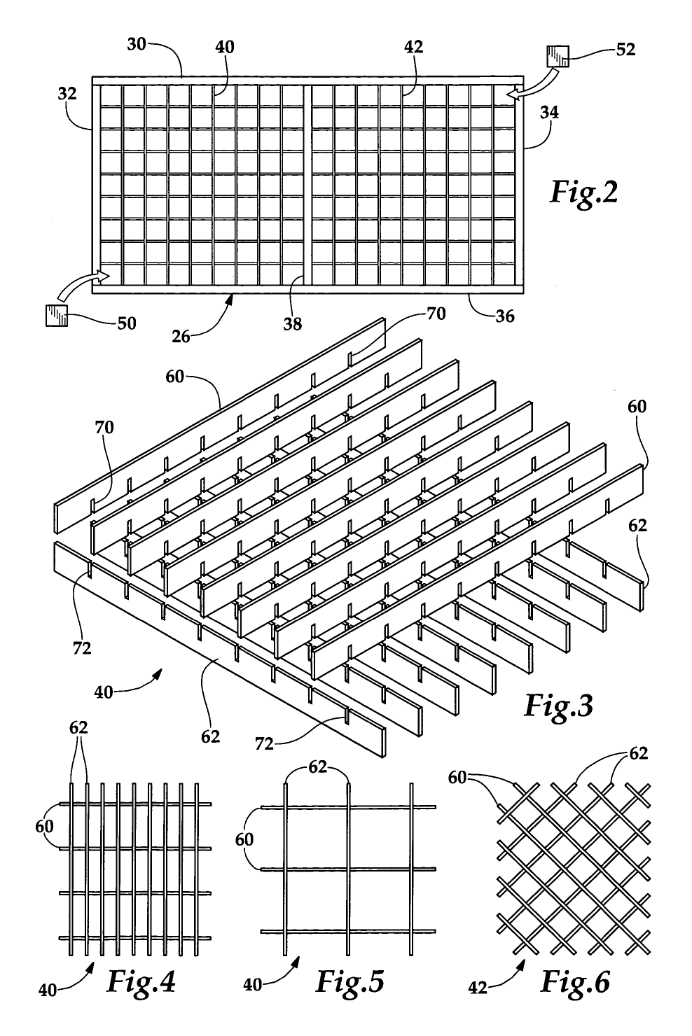

Referring to FIGS. 1 and 2, a hollow core board product in accordance with one form of the invention is shown in exploded perspective form and designated generally by the reference 20. In the illustrated embodiment, the product 20 is generally a rectilinear in form having a relatively thin, rectangular top and bottom skins 22 and 24, which may be made from a number of products including wood, and wood veneer or plastic laminate products, and the like. The skin may also be composed of other products such as wet or dry process hardboard, fibreboard, plastics, foils, metals, high-pressure laminate, painted metallic materials, and veneers of any kind. In the embodiment illustrated and described, the sheets or skins 22, 24 are formed or cut from relatively thin press board.

A generally rectilinear frame 26, may comprise four sides, 30, 32, 34 and 36 and one or more interior or cross braces 38. In the embodiment illustrated, these frame members are constructed of press board, cut to the appropriate lengths and assembled by fasteners, gluing/adhesives or other processes. However, frame members made of wood products or other materials may be used. In another form of the invention (see, e.g., FIG. 10) the core and skin may be provided as a hollow core board product without the frame.

In the hollow spaces formed by the frame members, the product of the invention utilizes a load-bearing, structurally sound grid member or members 40, 42. In the embodiment illustrated, two such grids occupy the two spaces defined by the frame having the single cross member 38. However, other configurations having fewer or more frame elements and correspondingly fewer or more grid structures may be utilized, or, as in FIG. 10, no frame at all. In accordance with one form of the invention, and is also shown in FIG. 2, one or more solid block numbers 50, 52, 54 may be inserted in correspondingly shaped openings in the grids 40, 42. As will be seen later with reference to FIGS. 11 and 12, these block numbers may be designed to accept fasteners, thereby providing convenient solid areas for receiving fasteners for attachment of other objects to the hollow core product 20, for enabling construction of structures utilizing multiple such hollow core boards, a combination of hollow core board panels with other panels, structural members, or the like.

Referring now to FIG. 3, the grid structure 40 will be seen to comprise a plurality of substantially similar relatively thin, elongated elements 60, 62. These elements 60, 62 in the embodiment illustrated and described herein are constructed or cut from the same type of press board product used to form the skins and frame members. However, any other sufficiently structurally sound and load-bearing material may be used to form the grid member 60, 62. For example, these materials may include hardboard, flake board, medium density fibreboard, chipboard, heavy cardboard or corrugated board, plastics, metals, wood or other wood products, fibreboard, or kraft board among others.

In the illustrated embodiment, the grid members 60 and 62 are substantially identical in length, height and thickness. In this regard, their thickness may range from about 0.025 in. to about ⅜ in. The height may range from about ¼ inch board to any desired height to construct a product of desired thickness. Each of the grid members 60 and 62 is formed with a plurality of spaced apart notches 70, 72. Preferably, these notches are substantially identical and extend halfway through the height of the grid member 60, 62, such that they may interengage in the manner generally indicated in FIG. 3 to form the grid of the form shown in FIG. 1. The width of the notches is preferably substantially similar to or only slightly greater than the thickness of the grid members 60, 62 so that the same may be received therein is indicated in FIG. 3. The center-to-center spacing of the notches 70, 72 may be any desired distance to form a grid of the desired load-bearing capacity. That is, if more grid members are used and are more closely spaced as shown in FIG. 4, for example, a stronger load-bearing surface will be formed than had they been more widely spaced as shown in FIG. 5, for example.

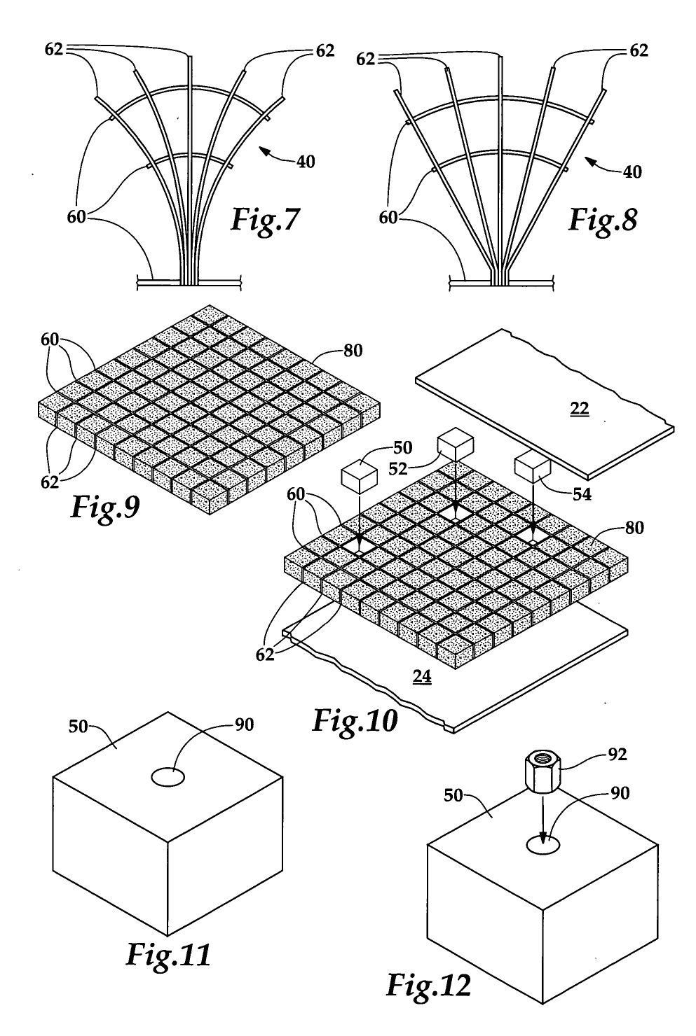

In the embodiment illustrated and described herein, the spacing may be anywhere from about ¼ inch up to about 1½ inch, which is the preferred spacing, to 3 in. or wider. In this manner, grid members 60 and 62 may be interlocked in any desired spacing along the respective grids, such that parallel grid members are spaced by either one or some multiple of the spacing between notches 70, 72. Thus, the grid spacing may be about 1½ inches, 3 in., 4½ inches, etc. in the embodiment illustrated, or may vary from one member 60 ,62 to the next. Moreover, the spacing between parallel grid elements or members 60 need not be the same as the spacing between parallel grid members 62. Hence, the provision of standard grid elements 60 and 62 makes possible the forms shown in FIGS. 5 through 8, as well as others. In this regard, the flexible nature of the relatively thin grid members 60, 62 makes possible various curved forms of structures as shown for example, in FIGS. 7 and 8. Moreover, while the finished grids might generally be placed in the frame in the manner shown in FIG. 1, diagonal grids as shown in FIG. 6 might also be utilized, as well as other forms for irregularly shaped products. Moreover, grid elements 60 and 62 may be of any desired length, such that they may be more or less continuously formed and cut to a desired length for a particular application. Accordingly, the grid members 60, 62 might be preformed/precut and supplied in lengths such as 4 ft., 6 ft., 8 ft., etc, and readily cut to desired lengths for a particular application such as the board product shown in FIGS. 1 and 2.

The grids as described above, may also be filled, if desired with foam fill or other formable materials 80. In those grid spaces in which blocks 50, 52 are to be placed, the material may be eliminated, or, if the fill is poured or otherwise installed in a single process, it maybe diecut or otherwise removed to receive the blocks. Various materials may be used for the filling 80, such as Styrofoam, styrene and other like materials. The use of such additional fill may improve the thermal and/or sound insulation properties of the product.

Finally, referring to FIGS. 10 through 12, as indicated in FIG. 10, the blocks 50, 52, 54 may be placed in any desired spaces in a grid, such that the blocks may be precut to fill any particular shape of grid space, for example see FIGS. 4 through 8. However, as indicated above, with a foam or other filling 80, the filling may be eliminated or otherwise cut or removed, for example die cut, in order to accommodate the blocks 50, etc. In FIGS. 11 and 12 two possible configurations of blocks 50 for receiving fasteners are shown. In FIG. 11, the block 50 is provided with a pre-drilled or preformed hole or bore 90 for receiving a fastener, while in the embodiment of FIG. 12, a fastener 92 is pressed into the opening or bore 90 to receive a meeting fastener, for example. When such blocks are used, skins 22 and/or 24 may also be predrilled, punched, perforated or otherwise marked to indicate the position of the center and/or fastener receiving bore 90 of the block.

It is also within the scope of the invention to provide a hollow core product with blocks 50, 52 placed at desired locations, without use of the grid 40 as described herein. In this regard, such blocks 50, 52 may be installed in a hollow core product in which the filling is a foam or other formable substance, or a corrugated paper “honeycomb” product or other hollow core products by diecutting or otherwise creating or forming a suitable space for receiving the block in the desired location or locations.

From the foregoing, it will be seen that the invention, in addition to providing a structurally stronger, non-warping and weight-bearing product is also readily capable of being easily fastened to other components. Moreover, the product described is considerably lighter in weight and less expensive to manufacture than current products such as plywood, solid wood, particle board or chipboard, and the like, when provided with appearance enhancing skins, veneers, foils or the like. By way of example, at current prices, the cost of providing a product, as described above with reference to FIG. 1 is approximately $0.48 per square foot, whereas the cost of a particle board product is about $0.78 per square foot and the cost of high-pressure laminate is about $1.00 per square foot.

The hollow core product of the invention provides a relatively inexpensive and light weight product for use in such applications as shelving, or as structural members, for example, in prefabricated panels for use in flooring, platforms, truck trailer or mobile home/travel trailer walls or partitions, office partitions or cubicle walls, portable dance floors, countertops exhibits, or the like, or for use as components of furniture products, such as modular furniture products which are preassembled or assembled by the consumer.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A hollow core board product having a load-bearing, non-warping core, said core comprising:
a grid having a preselected number of elongated linear grid members, said members being selected and configured to have a relatively high compression resistance, and being interlocked in a crossing pattern to form said grid, such that the number of grid members utilized and their spacing will determine a load bearing capacity of the hollow core board product.

2. A hollow core board product according to claim 1, wherein each of said elongated linear grid members comprises an elongate, generally rectilinear strip of material having a predetermined thickness and a plurality of spaced apart notches.

3. A hollow core board product according to claim 1, wherein said spaced apart notches are substantially identical and extend halfway through the height of each grid member such that they may interengage to form the grid.

4. A hollow core board product according to claim 1, wherein said spaced apart notches are substantially equally spaced, on a center-to-center spacing of from about ½ inch to about 3 inches.

5. A hollow core board product according to claim 2, wherein said spaced apart notches are of a width similar to the thickness of said grid members.

6. A hollow core board product according to claim 2, wherein said thickness of each of said elongated linear grid members is from about 0.025 in. to about ⅜ inch.

7. A hollow core board product according to claim 1, and further including at least one solid block member inserted at a desired location in said core.

8. A hollow core board product according to claim 7, wherein said at least one solid block is sized to fit in said grid.

9. A hollow core board according to claim 1, and further including a relatively thin skin attached to either side of said core.

10. A hollow core board according to claim 1 and further including a quantity of formable material placed in the open spaces formed by said grid.

11. A hollow core board product comprising:
a frame having a desired shape, and having one or more peripheral frame the members, forming an open space inside of said peripheral members;
a core shaped to fit in the open space on the side of said peripheral members and comprising grid having a preselected number of the elongated linear grid members, said members being selected and configured to have a relatively high compression resistance, and being interlocked in a crossing pattern to form said grid, such that the number of grid members utilized and their spacing will determine a load bearing capacity of the hollow core board product; and
a relatively thin skin attached to either side of said frame so as to enclose said core therein, said skin having a peripheral shape conforming to the desired shape of said frame.

12. A hollow core board product according to claim 11, wherein each of said elongated linear grid members comprises an elongate, generally rectilinear strip of material having a predetermined thickness and a plurality of spaced apart notches.

13. A hollow core board product according to claim 11, wherein said spaced apart notches are substantially identical and extend halfway through the height of each grid member such that they may interengage to form the grid.

14. A hollow core board product according to claim 11, wherein said spaced apart notches are substantially equally spaced, on a center-to-center spacing of from about ½ inch to about 3 inches.

15. A hollow core board product according to claim 12, wherein said spaced apart notches are of a width similar to the thickness of said grid members.

16. A hollow core board product according to claim 12, wherein said thickness of each of said elongated linear grid members is from about 0.025 in. to about 3/18 inch.

17. A hollow core board product according to claim 11, and further including at least one solid block member inserted at a desired location in said core and positioned so as to closely abut at least one of said skins.

18. A hollow core board product according to claim 17, wherein said at least one solid block is sized to fit in said grid.

19. A hollow core board product comprising:
a core comprising a grid having a preselected number of enlongated linear grid members, said members being selected and configured to have a relatively high compression resistance, and being interlocked in a crossing pattern to form said grid, such that the number of grid members utilized and their spacing will determine a load bearing capacity of the hollow core board product;
a relatively thin skin attached to either side of said frame so as to enclose said core therein, said skin having a peripheral shape conforming to the desired shape of said frame, and
at least one solid block member inserted at a desired location in said core and positioned so as to closely abut at least one of said skins.

20. A hollow core board product according to claim 19 and further including a frame, said core being shaped to fit in said frame.

21. A hollow core board product according to claim 19, wherein said at least one solid block is sized to fit in said grid.
